(19) United States
(12) Patent Application Publication
(10) Pub. No.: US 2019/0184289 A1
(43) Pub. Date: Jun. 20, 2019

(54) Inverted Progression

(71) Applicant: Wargaming.net Limited, Nicosia (CY)

(72) Inventor: Sergey Burkatovskiy, Minsk (BY)

(21) Appl. No.: 16/053,423

(22) Filed: Aug. 2, 2018

Related U.S. Application Data
(60) Provisional application No. 62/607,526, filed on Dec. 19, 2017.

(51) Int. Cl. A63F 13/69; A63F 13/75; A63F 13/73

(52) U.S. Cl. CPC A63F 13/69; A63F 13/75; A63F 2300/201; A63F 2300/609; A63F 13/73

(57) ABSTRACT

Methods, systems, and apparatuses are described herein for providing an interactive application, such as a video game, with a hierarchy of tiers and a hierarchy of game items. Higher tiers may correspond to better game items, and lower tiers may correspond to worse game items. Game rewards awarded to a user for using a particular item may be inversely related to the corresponding tier level of the particular item. Game rewards may comprise experience points, credits, levels, or the like. New users of the interactive application may be provided access to a tier above the lowest tier of the hierarchy and thereby able to access better game items than those corresponding to the lowest tier. A prestige tier may be established requiring a quantity of game rewards for access, and users may thereby be able to access the prestige tier faster by using lower, and potentially more difficult, tiers.

### CROSS-REFERENCE TO RELATED APPLICATIONS

This application claims priority to and claims the benefit of U.S. Provisional Patent Application No. 62/607,526, which was filed on Dec. 19, 2017, and is hereby incorporated by reference in its entirety.

### FIELD

Aspects described herein generally relate to providing an interactive application with a hierarchy of tiers, such as difficulty tiers. More specifically, aspects provide for the establishment of a hierarchy of tiers and a hierarchy of game items, wherein game rewards awarded with a particular game item are inversely related to a tier corresponding to the particular game item.

### BACKGROUND

Interactive applications, such as video games, may reward users for their performance by, for example, providing such users access to progressively better game items, levels, story, or other such rewards. For example, a shooter game may reward users for progress and/or performance by providing progressively better guns, characters, ammunition, elements of a story, or other rewards. Such rewards may correspond to tiers such that, for example, in a multiplayer game, a “Beginner Rank” player may be forced to play with other similarly-ranked users and may further be forced to use “Beginner Rank” items. Though the “Beginner Rank” player may be given access to higher-ranked items, such items may provide worse rewards, such as fewer experience points.

Because interactive applications may feature both tiers and progressively better rewards, users may become discouraged and stop playing an interactive application before they enjoy the benefit of the better rewards. For example, a player in the “Beginner Tier” of a car racing video game may be forced to use an unsatisfying and slow car that earns relatively few reward/experience points and, as a result, may quit the game before accessing higher tiers featuring faster and more interesting cars that earn more points. In some popular multiplayer titles, players may be forced to invest tens to hundreds of hours before certain gameplay features (e.g., popular gameplay items) are available. For multiplayer video games, this result can be undesirable, as this creates player churn which ultimately means a smaller, less engaged player base. There is thus an ongoing need to optimize interactive software in order to provide a better and more satisfying experience to users.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed to establishing, in an interactive application, a hierarchy of tiers corresponding to a hierarchy of game items, wherein game rewards are awarded in a manner inversely related to tier levels of game items used.

A hierarchy of game tiers may be configured such that higher tiers are associated with better game items of a hierarchy of game items. Conversely, lower tiers of the hierarchy of tiers may be associated with worse game items of the hierarchy of game items. As used herein, the term better may comprise a subjective or objective evaluation of the game item in question: for example, an item may be more aesthetically pleasing, be easier to use, be more fun to play, and/or may be more powerful. Game rewards, such as experience points, may be awarded in an inverted manner such that more rewards are provided for use of lower tiers (e.g., those associated with worse items) than are awarded for higher tiers (e.g., those associated with better items). Such rewards may be used in a tier to, for example, improve game items within a tier or portions of the interactive application associated with the game items, such that, for example, game items within a lower tier may become superior to game items within a higher tier. For example, lower tiers may be associated with a game reward multiplier larger than that of higher tiers, but may force players to use a bicycle rather than a motorcycle. The players may nonetheless be able to use game rewards to improve the bicycle such that it has better properties than the motorcycle. Similarly, the players may nonetheless be able to use game rewards to improve the rider of the bicycle to improve the performance of the bicycle. Users beginning the interactive application may be given access to a tier above a lowest tier level such that they may begin the game with relatively better items than they would if they had to start at the bottom of the tiers.

Tiers may be associated with one or more limitations or rules in view of the hierarchy described above. Tiers may be configured such that users may only use items corresponding to that tier against other users using items from that tier or similar tiers. The hierarchy of game items may be configured based on parameters of the game items, such as their performance in-game. For example, a faster car may make a game easier, and may thereby be placed higher on a hierarchy of game items as compared to a slower car. A tier may be associated with a game reward penalty. Tiers may be configured such that only so many users may use a corresponding game item at the same time. Tiers may have a corresponding quantity of experience points such that a user may gain experience points in the tier or corresponding game items.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 illustrates network architecture that may be used to implement one or more illustrative aspects described herein.

FIG. 2 illustrates a hierarchy of tiers, each with corresponding items.

FIG. 3 shows a simplified network including an inverted progression computing platform.

FIG. 4 shows a flow chart comprising steps in accordance with features described herein.

### DETAILED DESCRIPTION

In the following description of the various embodiments, reference is made to the accompanying drawings, which form a part hereof, and in which is shown by way of illustration various embodiments in which aspects described herein may be practiced. It is to be understood that other embodiments may be utilized and structural and functional modifications may be made without departing from the scope of the described aspects and embodiments. Aspects described herein are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

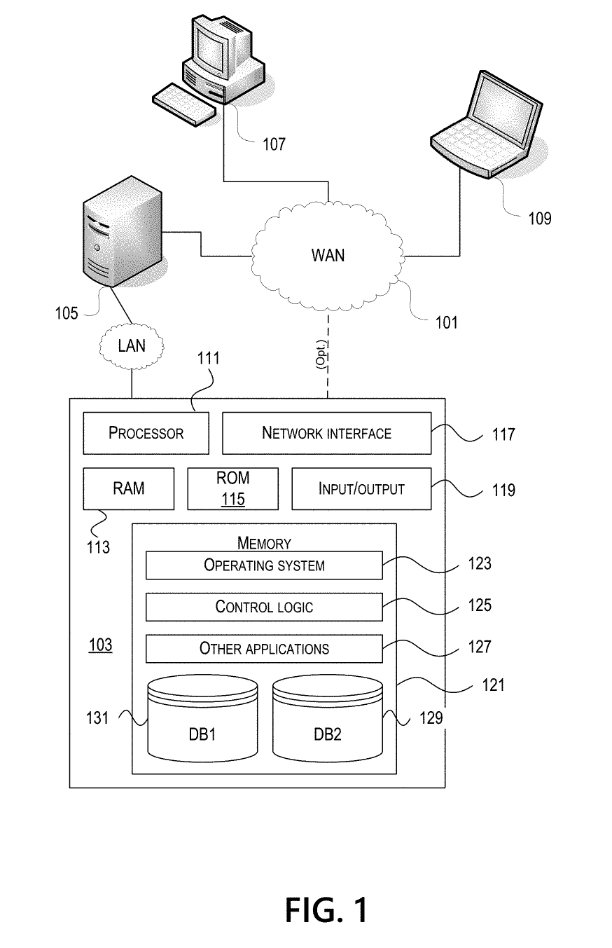

FIG. 1 illustrates one example of a network architecture and data processing device that may be used to implement one or more illustrative aspects described herein. Various network nodes 103, 105, 107, and 109 may be interconnected via a wide area network (“WAN”) 101, such as the Internet. Other networks may also or alternatively be used, including private intranets, corporate networks, LANs, wireless networks, personal networks (“PAN”), and the like. A network 101 is for illustration purposes and may be replaced with fewer or additional computer networks. A local area network (“LAN”) may have one or more of any known LAN topology and may use one or more of a variety of different protocols, such as Ethernet. Devices 103, 105, 107, 109 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include a data server 103, a web server 105, and a client computers 107, 109. The data server 103 provides overall access, control and administration of databases and control software for performing one or more illustrative aspects described herein. The data server 103 may be connected to the web server 105 through which users interact with and obtain data as requested. Alternatively, the data server 103 may act as a web server itself and be directly connected to the Internet. The data server 103 may be connected to the web server 105 through the network 101 (e.g., the Internet), via direct or indirect connection, or via some other network. Users may interact with the data server 103 using remote computers 107, 109, e.g., using a web browser to connect to the data server 103 via one or more externally exposed web sites hosted by the web server 105. Client computers 107, 109 may be used in concert with the data server 103 to access data stored therein, or may be used for other purposes. For example, from a client device 107, a user may access the web server 105 using an Internet browser, as is known in the art, or by executing a software application that communicates with the web server 105 and/or the data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by the web server 105 and the data server 103 may be combined on a single server.

Each component 103, 105, 107, 109 may be any type of known computer, server, or data processing device. The data server 103, e.g., may include a processor 111 controlling overall operation of the rate server 103. The data server 103 may further include Random Access Memory (“RAM”) 113, Read Only Memory (“ROM”) 115, a network interface 117, input/output interfaces 119 (e.g., keyboard, mouse, display, printer, etc.), and memory 121. I/O 119 may include a variety of interface units and drives for reading, writing, displaying, and/or printing data or files. The memory 121 may further store operating system software 123 for controlling overall operation of the data processing device 103, control logic 125 for instructing the data server 103 to perform aspects described herein, and other application software 127 providing secondary, support, and/or other functionality which may or may not be used in conjunction with other aspects described herein. The control logic may also be referred to herein as the data server software 125. Functionality of the data server software may refer to operations or decisions made automatically based on rules coded into the control logic, made manually by a user providing input into the system, and/or a combination of automatic processing based on user input (e.g., queries, data updates, etc.).

The memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109) as described herein may be spread across multiple data processing devices, for example, to distribute processing load across multiple computers, to segregate transactions based on geographic location, user access level, quality of service (“QoS”), etc.

One or more aspects described herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) Hypertext Markup Language (“HTML”) or Extensible Markup Language (“XML”). The computer executable instructions may be stored on a computer readable medium such as a hard disk, optical disk, removable storage media, solid state memory, RAM, etc. The functionality of the program modules may be combined or distributed as desired in various embodiments. In addition, the functionality may be embodied in whole or in part in firmware or hardware equivalents such as integrated circuits, field programmable gate arrays (“FPGA”), and the like. Particular data structures may be used to more effectively implement one or more aspects, and such data structures are contemplated within the scope of computer executable instructions and computer-usable data described herein.

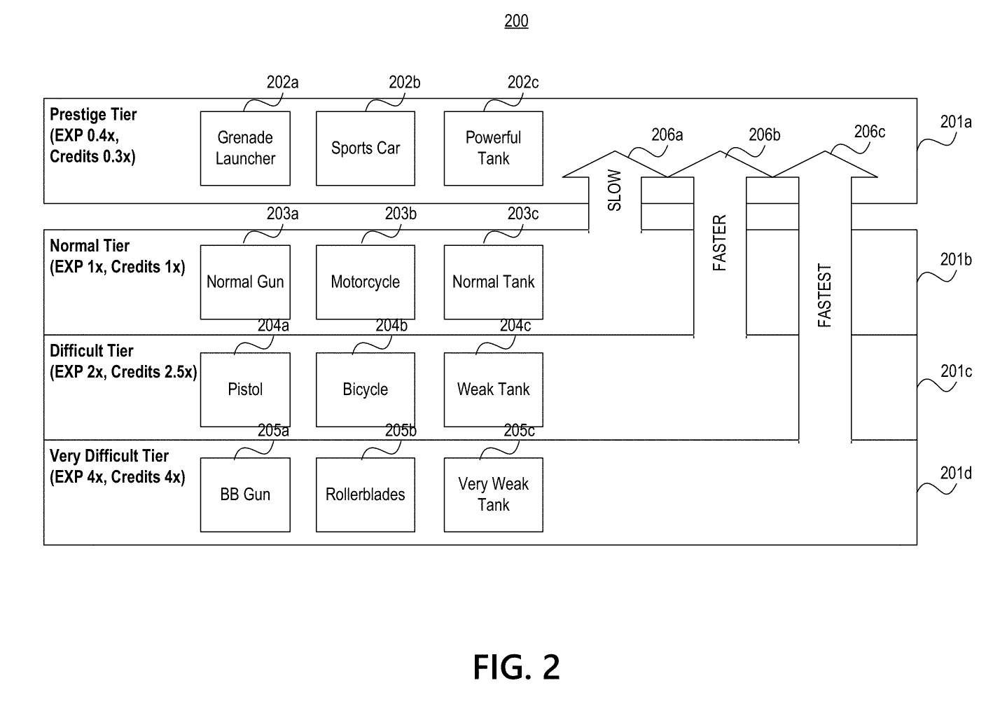

FIG. 2 shows one example of a hierarchy of tiers 200. The hierarchy of tiers 200 depicted has a prestige tier 201a, a normal tier 201b, a difficult tier 201c, and a very difficult tier 201d. The tiers depicted, including their names, are exemplary; any number of tiers may be configured. The tiers depicted may be categories of tiers such that, for example, the normal tier 201b may comprise a plurality of sub-tiers, levels, or other similar segments.

The hierarchy of tiers 200 may be arranged in any order and based on any method of comparing tiers. For example, one game may have a hierarchy of tiers based on difficulty, whereas another may have a hierarchy of tiers based on character class, team, or other such classifications. For simplicity, FIG. 2 depicts a hierarchy on a single vertical axis and based solely on the quality of game items such that, for example, the normal tier 201b corresponds to basic game items such as a normal tank 203c, the difficult tier 201c corresponds to advanced game items such as weak tank 204c, and the prestige tier 201a corresponds to easy game items such as the powerful tank 202c. Multiple axes and configurations of hierarchies may exist: as a simplistic example, a World War 2 shooter game could feature a two-dimensional hierarchy corresponding to difficulty and country (e.g., the U.S., Germany, Japan).

The normal tier 201b may be the tier which a new player of the interactive application may start. The normal tier is associated with an amount of game rewards, depicted in FIG. 2 as a 1× multiplier of experience points (“EXP”) growth and credits growth. Such a multiplier may be used to determine adjusted game rewards by, for example, multiplying a base level of game rewards with the multiplier. The normal tier 201b depicted in FIG. 2 may be associated with three game items: a normal gun 203a, a motorcycle 203b, and a normal tank 203c. Such game items, as well as the rate of game rewards depicted, are exemplary: any tier may have any configuration of game rewards and game items. The normal tier 201b need not be the very bottom tier in the hierarchy: new players may be given access to desirable items in the normal tier 201b (e.g., the motorcycle 203b) and may elect to play in lower tiers (and use worse items, like the bicycle 204b in the difficult tier 201c).

The difficult tier 201c may be a tier which a player may select and/or earn via game rewards. The difficult tier 201c may be associated with a larger quantity of game rewards, depicted in FIG. 2 as a 2× multiplier of EXP growth and 2.5× credits growth. The difficult tier 201c depicted in FIG. 2 may be associated with three game items: a pistol 204a, bicycle 204b, and weak tank 204c. A player may optionally play using the difficult tier 201c against other users using the difficult tier 201c, other users using the normal tier 201b, or the like. Accordingly, the difficult tier 201c thereby is associated with better game rewards but worse game items than the normal tier 201b.

The very difficult tier 201d may be a tier which a player may select and/or earn via game rewards, like difficult tier 201c. The very difficult tier 201d may be associated with an even larger quantity of game rewards, depicted in FIG. 2 as a 4× multiplier of EXP growth and credits growth. The very difficult tier 201d depicted in FIG. 2 may be associated with three game items: a BB gun 205a, rollerblades 205b, and a very weak tank 205c. A player may optionally play using the very difficult tier 201d against other users using the very difficult tier 201d, other users using the difficult tier 201c, other users using the normal tier 201b, or the like. Accordingly, the very difficult tier 201d thereby is associated with better game rewards but worse game items than both the normal tier 201b and/or the difficult tier 201c.

The prestige tier 201a may be a tier which is desirable for any number of reasons, such as featuring different gameplay and/or more interesting game items. The tier may be associated with a lower (or, potentially, negative) quantity of game rewards, depicted in FIG. 2 as a 0.4× multiplier of EXP growth and 0.3× credits growth. The prestige tier 201a depicted in FIG. 2 may be associated with three game items: a grenade launcher 202a, sports car 202b, and powerful tank 202c. The actual multipliers used are illustrative only, may vary in other implementations, and are secondary to the use of an inverse relationship between tier level and player reward.

Rather than selecting a tier, a player may be presented the option of simply picking an item corresponding to a tier. For example, rather than showing players a tier list similar to the hierarchy of tiers 200, a game may instead simply provide the player with a plurality of items, each corresponding to one of a plurality of tiers.

Tiers may be configured such that players using a particular may only play against players from pre-specified tiers. For example, players using an item from the prestige tier 201a may be limited to play only with other players using items from prestige tier 201a. As another example, players using items from the normal tier 201b may be limited to playing with players using game items from the normal tier 201b, the difficult tier 201c, and/or the very difficult tier 201d. As another example, a multiplayer game may be configured to only allow players to compete against other players using a preselected subset of game items corresponding to multiple tiers (e.g., only melee weapons corresponding to any tier, only pistols corresponding to the difficult tier 201c and/or very difficult tier 201d, or the like).

Similarly, tiers may be configured such that only a certain number of players may use a tier and/or corresponding items. For example, a game may be configured with a plurality of characters corresponding to each tier in a hierarchy of tiers. In that example, the game may prevent use of the same character twice, such that each player must select a different character from one of a plurality of tiers. As another example, only a predetermined quantity of players may be allowed to use a certain tier (e.g., the prestige tier 201a) at once, and/or only a predetermined quantity of players may be allowed to use a certain game item (e.g., the sports car 202b) at once.

Arrows 206a-206c illustrate a speed of gameplay progression. As depicted by the separation of the prestige tier 201a from the other tiers 201b-201d, the prestige tier 201a may require a quantity of game rewards for access. For example, the prestige tier 201a may require a certain number of experience points. A player playing the interactive software using the normal tier 201b may reach the prestige tier slowly, as depicted by the arrow 206a, because the rate of game rewards is relatively slow. Accordingly, a player may reach the prestige tier 201a faster by playing using the difficult tier 201c (as depicted by the arrow 206b), and may reach the prestige tier 201a fastest by playing using the very difficult tier 201d (as depicted by the arrow 206c).

Performance of an item in a tier may increase, and game rewards may be used to improve game items in a tier. In some instances, the performance of an item in a tier may become superior to the performance of an item in a relatively higher tier. For example, a player may elect to play the very difficult tier 201d and use experience points gained from playing using the tier to improve the BB gun 205a until it is better than the pistol 204a, though the initial configuration of BB gun 205a may be significantly weaker than the pistol 204a. Players may, instead of using gameplay rewards to access the prestige tier 201a, instead elect to stay in a lower tier (e.g., the normal tier 201b) and invest gameplay rewards in items corresponding to the lower tier (e.g., the normal tank 203c).

Additionally or alternatively, game rewards may be used to improve aspects of the interactive application associated with a tier or game item. For example, a game item may be a tank, and the tank may be associated with one or more bullet types, crew, fire extinguisher, repair kit, radio, and/or other similar portions of the interactive application. Such portions may be upgraded by a player using game rewards. In this manner, game rewards used to improve a game item (e.g., the offensive or defensive power of a tank) may be considered primary upgrading, whereas game rewards used to upgrade another aspect of the interactive application associated with the game item and/or the tier of the game item (e.g., a crew that may pilot the tank) may be considered secondary upgrading. Such portions may be limited to one or more game items or tiers such that, for example, a powerful crew might only be used by a first tier, a basic crew may be used by any tier, and the basic crew may be upgraded using game rewards to be increasingly as powerful as the powerful crew.

For example, FIG. 2 may depict a tier system in an online multiplayer shooter game wherein players may earn and choose one of the normal tier 201b, the difficult tier 201c, the very difficult tier 201d, and/or the prestige tier 201a. A first player may choose the very difficult tier 201d and play against a second player using the normal tier 201b and a third player using the prestige tier 201a. In this manner, the first player may have a harder time beating the second and third players, but their rewards for doing so may be considerably higher, potentially speeding up their progress towards achieving access to the prestige tier 201a and/or their progress in improving a game item in the very difficult tier 201d. The second player may experience slower progress towards achieving access to the prestige tier 201a, may earn relatively fewer game rewards, and/or may already have access to the prestige tier 201a. The third player using the prestige tier 201a may have their game rewards significantly lessened.

One or more tiers may be associated with a penalty. Such a penalty may comprise a reduction in gameplay rewards, a limitation as to one or more portions of gameplay, other similar gameplay downsides. For example, prestige tier 201a may be associated with a reduction of in-game currency such that a player may essentially be required to pay to access the tier. As another example, a tier may prevent a player from accessing specific in-game maps, gameplay modes, other aspects of a game. As yet another example, an item in a tier may lose experience points, such that a game item may become weaker over time. Such a tier may be correlated with performance such that the tier may reduce gameplay rewards of a player in response to poor in-game performance by the player. The penalty may not be quantitative, but may instead be qualitative: for example, a player may be required to forego using an aesthetically appealing character.

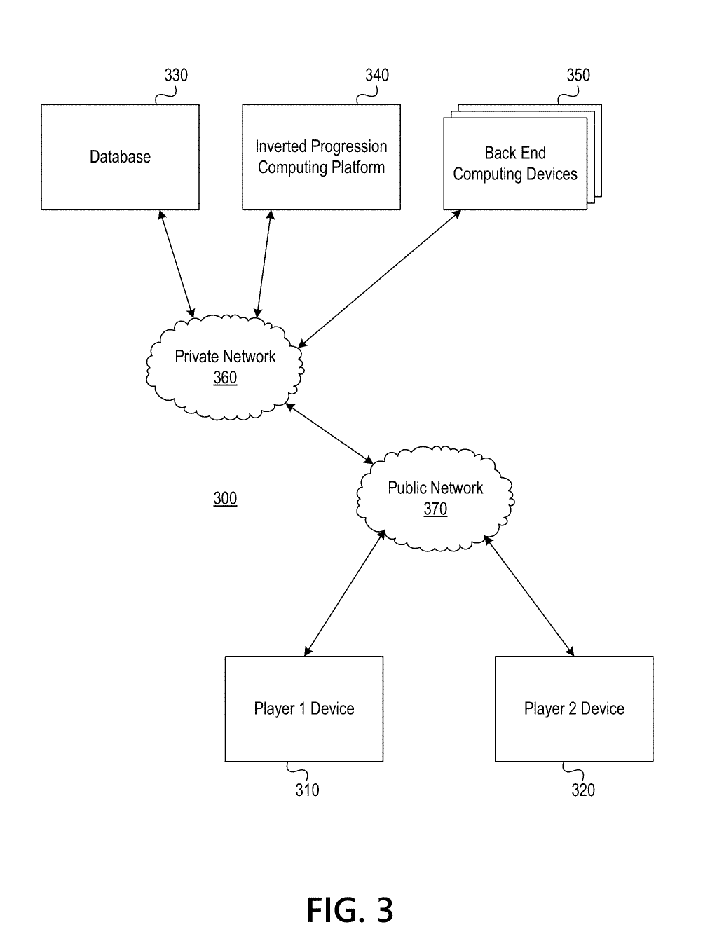

FIG. 3 depicts a simplified network upon which the features described herein may be implemented, with a particular focus on how the hierarchy of tiers 200 may be implemented for a video game.

An inverted progression computing platform 340 may be connected via a private network 360 to a database 330, back end computing devices 350, and ultimately, through a public network 370, to player devices such as a player 1 device 310 and a player 2 device 320.

The inverted progression computing platform 340 may be a computing device which administrates an inverted progression system, such as the hierarchy of tiers 200. The inverted progression computing platform 340 may be a part of a video game such that, for example, the inverted progression computing platform 340 is a module associated with and/or part of a video game executable. The inverted progression computing platform 340 may additionally or alternatively interface with the back end computing devices 350 to, for example, provide server functionality for a video game. For example, the inverted progression computing platform 340 may be a module of an authentication server for a multiplayer online video game, and the back end computing devices 350 may be devices handling other portions of the multiplayer online video game (e.g., keeping score, administrating game rules).

Player devices, such as the player 1 device 310 and the player 2 device 320, may connect, via public network 370 and/or private network 360, to the inverted progression computing platform 340. The player devices may be personal computers, video game consoles, or other similar client computers. Connection by the player devices to the inverted progression computing platform 340 may comprise authentication using authentication credentials, which may be validated against credentials stored by database 330. For example, the player 1 device 310 may send authentication credentials to the inverted progression computing platform 340 to access an account in a video game and, thereby, the game rewards associated with the account. Those game rewards may be used to, for instance, determine whether a player is allowed to access a tier in the hierarchy of tiers 200.

The database 330 may store information about the hierarchy of tiers 200 and/or game items and/or game rewards. For example, the database 330 may store an indication that a certain game item corresponds to one or more tiers in the hierarchy of tiers 200. The database 330 may additionally or alternatively store information corresponding to game rewards with items, such as an amount of experience points invested in a game item or portion of the interactive application associated with the game item and/or tier (e.g., information corresponding to primary and/or secondary upgrading). The player devices may access this information via the inverted progression computing platform 340 or directly over the private network 360 and/or the public network 370. For example, game executing on the player 1 device 310 may download, from the database 330, the hierarchy of tiers 200 to determine which game items are available to a player.

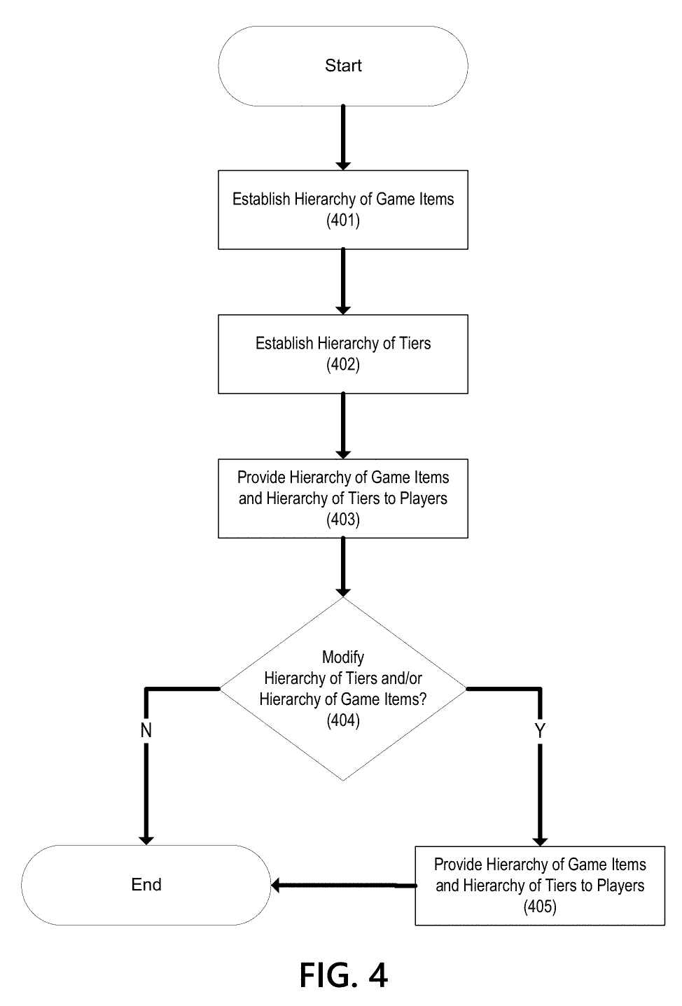

FIG. 4 shows a flow chart depicting steps which may be taken in accordance with features described herein.

In step 401, the inverted progression computing platform may establish a hierarchy of game items. Game items may comprise any appropriate aspect of a game, and may vary depending on the genre and/or nature of the game: for example, in a shooter game, the items may comprise guns, whereas in an adventure game, the items may comprise a rubber chicken with a pulley in the middle. The items may be arranged on a hierarchy based on any appropriate measure or dimensions. For example, a Role Playing Game (“RPG”) may arrange swords based on their offensive properties, but shields based on their defensive properties. The hierarchy need not be one-dimensional based on a single property, but may be based on any number of qualitative or quantitative measurements. For example, one gun may have a higher rate of fire but a lower damage amount as compared to a second gun, and yet the guns may be on the same tier of the hierarchy of game items because players perceive the guns to be of equal utility. The items may be associated with a quantity of rewards, such as experience points. The hierarchy of game items may indicate portions of the interactive application that are associated with the hierarchy of game items. For example, game items higher on a hierarchy of tanks may have access to a more desirable crew or weapons, whereas game items lower on the hierarchy may have access to a less desirable crew or weapons. Such portions of the interactive application associated with the hierarchy of game items may be improved with game rewards such that, for example, a less desirable crew may be upgraded to become more powerful and/or useful.

In step 402, the inverted progression computing platform may establish a hierarchy of tiers (e.g., the hierarchy of tiers 200). Each tier may comprise one or more game items from the hierarchy of game items. The hierarchy of game items may correspond to the hierarchy of tiers such that worse items correspond to lower tiers and better items correspond to higher tiers. For example, as discussed above with regard to FIG. 2, a higher tier may correspond to a powerful car (e.g., the prestige tier 201a comprising the sports car 202b), whereas a lower tier may correspond to rudimentary transportation (e.g., the very difficult tier 201d corresponding to the rollerblades 205b). The hierarchy need not be based on desirability or power. For example, one tier may correspond to a weak but fast tank whereas another tier may correspond to a powerful but slow tank, such that the hierarchy of tiers is based on speed and/or power. The hierarchy may be based on initial properties of the game items, such that game items (and/or portions of the interactive application associated with such game items) may later be improved using rewards such that game items on lower tiers are superior to game items on higher tiers.

The hierarchy of tiers may be configured such that each tier corresponds to game rewards. For example, as also discussed above with regard to FIG. 2, each tier in the hierarchy of tiers may correspond to a predetermined number of game rewards, a game reward multiplier, a type of game rewards, or other similar game rewards configurations. The hierarchy of tiers may be configured such that higher tiers correspond to fewer and/or worse game rewards, whereas lower tiers correspond to more and/or better game rewards. In this manner, the hierarchy of tiers may be configured to incentivize players to play with relatively worse game items or worse game modes. For example, a player may be willing to play with a worse item in a lower game tier, but use the game rewards received in the lower game tier to improve the worse item and/or portions of the interactive application associated with the worse item.

The hierarchy of tiers and the hierarchy of game items may be stored by the inverted progression computing platform. For example, the hierarchy of tiers and the hierarchy of game items may be stored in a database using Structured Query Language (“SQL”) and may be modified by game administrators as desired. The hierarchy of tiers and hierarchy of game items may thereby be flexible and easily changed without significant modification to, for example, game executable files.

In step 403, one or more players may connect to the game, and the inverted progression computing platform may establish the hierarchy of tiers and the hierarchy of game items. For example, a players may connect to a game server, and the game server may use the inverted progression computing platform to provide the player access to one or more tiers based on, for example, game rewards associated with the player. If the player is new, the inverted progression computing platform may provide the player with access to a tier above the lowest tier in the hierarchy of tiers, which may provide the player with better game items but relatively fewer game rewards.

In step 404, the inverted progression computing platform and/or a game administrator may determine whether to modify the hierarchy of tiers and/or the hierarchy of game items. The inverted progression computing platform may be configured to determine whether to modify the hierarchy of tiers and/or the hierarchy of game items based on analysis of gameplay data. For example, the inverted progression computing platform may receive and analyze and/or be configured log and analyze a win and/or loss rate with a particular game item, a frequency with which a particular tier and/or game item is used, or similar information about gameplay. This step needs not be performed by the inverted progression computing platform, but may additionally or alternatively be performed by a game administrator.

If the inverted progression computing platform and/or the game administrator determine to not modify the hierarchy of tiers and/or the hierarchy of game items, the flowchart may end.

If the inverted progression computing platform and/or the game administrator determine to modify the hierarchy of tiers and/or the hierarchy of game items, in step 405, the inverted progression computing platform may modify the hierarchy of tiers and/or the hierarchy of game items. Modification may include changing entries in a database comprising the hierarchy of tiers and/or the hierarchy of game items.

Modification of the hierarchy of tiers may comprise modifying the placement of a particular tier in the hierarchy, modifying the game rewards (e.g., the game reward multiplier) associated with a particular tier, modifying which game items are associated with the particular tier, or any other such modification. For example, a game administrator may determine that a particular tier is rarely used by players because the balance of game rewards and added difficulty (via, for example, weaker game items) is poor. As a result, the game administrator may modify the particular tier to provide more or better game rewards, correspond to better game items, or the like. Additionally or alternatively, the game administrator may weaken corresponding game items and/or associate the particular tier with fewer or worse game rewards.

Modification of one or more game items and/or the hierarchy of game items may comprise modifying a parameter of a game item, the location of a game item in the hierarchy of game items, or the like. For example, a game administrator may determine that a particular in-game character available in a tier is disproportionately weak such that players rarely use the character, or that the character is disproportionately strong such that players overwhelmingly choose the character when using the corresponding tier. The game administrator may modify parameters of the character, move the character to a different tier, or even delete the character to further game balance.

Modification may comprise enforcing the modification in the game. The inverted progression computing platform may be configured to ensure that all players comply with the modified version of the hierarchy of game items and/or the hierarchy of tiers. For example, if the game is a multiplayer shooting game, the inverted progression computing platform may ensure that future shooting game matches use the modified versions of the hierarchy of game items and/or the hierarchy of tiers.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method comprising:
establishing, by an interactive application executing on a computing device, a hierarchy of tiers corresponding to a hierarchy of game items, wherein higher tiers are associated with better game items of the hierarchy of game items, wherein lower tiers are associated with worse game items of the hierarchy of game items, and wherein an amount of game rewards awarded when a user uses a desired game item is inversely related to a corresponding tier level of the desired game item;
detecting a new user connecting to the interactive application; and
providing the new user access to game items associated with one or more tiers above a lowest tier level.

2. The method of claim 1, wherein the game rewards comprise one or more of: experience points, game currency, or attributes of one or more game items of the hierarchy of game items.

3. The method of claim 1, further comprising:
determining that a first tier is associated with a penalty; and
applying, in response to the new user accessing the first tier, the penalty to the user.

4. The method of claim 1, further comprising:
providing, to the user, a basic game item of the hierarchy of game items, wherein the basic game item is associated with a first game reward multiplier;
providing, to the user, an advanced game item of the hierarchy of game items, wherein the advanced game item is worse than the basic game item, wherein the advanced game item corresponds to a first tier that is lower than a second tier of the basic game item, and wherein the advanced game item is associated with a second game reward multiplier that is greater than the first game reward multiplier; and
providing gameplay to the user via the interactive application, wherein providing gameplay to the user comprises allowing the user to use either the basic game item or the advanced game item.

5. The method of claim 4, wherein providing gameplay to the user via the interactive application further comprises providing a second gameplay option wherein, during gameplay, the user may only use the basic game item or the advanced game item.

6. The method of claim 4, wherein providing gameplay to the user via the interactive application comprises preventing the user from using the advanced game item based on determining that a quantity of advanced game items in use by other users meets a threshold.

7. The method of claim 4, further comprising:
providing, to the user, an easy game item of the hierarchy of game items, wherein the easy game item is better than the basic game item, wherein the easy game item corresponds to a third tier that is higher than the second tier of the basic game item, and wherein the easy game item is associated with a third game reward multiplier that is smaller than the first game reward multiplier.

8. The method of claim 4, wherein each game item comprises a tank vehicle, and the method further comprises, responsive to user input, upgrading a crew of a particular tank vehicle in redemption for a predetermined amount of game rewards.

9. The method of claim 4, further comprising:
determining a quantity of game rewards corresponding to performance of the user during the gameplay;
determining that the user used the advanced game item;
determining adjusted game rewards by multiplying the quantity of game rewards by the second game reward multiplier; and
providing the adjusted game rewards to the user.

10. The method of claim 9, further comprising:
receiving, from the user, an indication of one of a plurality of quantities of game rewards, each corresponding to a different tier, wherein providing the adjusted game rewards to the user comprises modifying the one of the plurality of quantities of game rewards based on the adjusted game rewards.

11. The method of claim 1, further comprising:
receiving gameplay data corresponding to the hierarchy of tiers; and
modifying, based on the gameplay data, the hierarchy of tiers, wherein modifying the hierarchy of tiers comprises associating a first game item with a first tier, wherein the first game item was previously associated with a second tier different than the first tier.

12. The method of claim 11, further comprising:
receiving the gameplay data, wherein the gameplay data comprises an indication of a win rate corresponding to the first game item.

13. The method of claim 11, further comprising:
receiving the gameplay data, wherein the gameplay data comprises an indication of a frequency which players use the first game item.

14. The method of claim 11, wherein the first tier is lower than the second tier in the hierarchy of tiers.

15. A computing device comprising:
one or more processors; and
memory storing instructions that, when executed by the one or more processors, cause the computing device to:
establish, by an interactive application, a hierarchy of tiers corresponding to a hierarchy of game items, wherein higher tiers are associated with better game items of the hierarchy of game items, wherein lower tiers are associated with worse game items of the hierarchy of game items, and wherein an amount of game rewards awarded when a user uses a desired game item is inversely related to a corresponding tier level of the desired game item;
detect a new user connecting to the interactive application; and
provide the new user access to game items associated with one or more tiers above a lowest tier level.

16. The computing device of claim 15, wherein the instructions further cause the computing device to:
provide, to the user, a basic game item of the hierarchy of game items, wherein the basic game item is associated with a first game reward multiplier;
provide, to the user, an advanced game item of the hierarchy of game items, wherein the advanced game item is worse than the basic game item, wherein the advanced game item corresponds to a first tier that is lower than a second tier of the basic game item, and wherein the advanced game item is associated with a second game reward multiplier that is greater than the first game reward multiplier; and
provide gameplay to the user via the interactive application, wherein providing gameplay to the user comprises allowing the user to use either the basic game item or the advanced game item.

17. The computing device of claim 15, wherein the instructions further cause the computing device to:
receive gameplay data corresponding to the hierarchy of tiers; and
modify, based on the gameplay data, the hierarchy of tiers, wherein modifying the hierarchy of tiers comprises associating a first game item with a first tier, wherein the first game item was previously associated with a second tier different than the first tier.

18. A system comprising:
an inverted progression computing platform; and
a player computing device;
wherein the inverted progression computing platform is configured to:
establish, by an interactive application, a hierarchy of tiers corresponding to a hierarchy of game items, wherein higher tiers are associated with better game items of the hierarchy of game items, wherein lower tiers are associated with worse game items of the hierarchy of game items, and wherein an amount of game rewards awarded when a user uses a desired game item is inversely related to a corresponding tier level of the desired game item;
detect a new user connecting to the interactive application; and
provide the new user access to game items associated with one or more tiers above a lowest tier level; and
wherein the player computing device is configured to:
connect to the interactive application; and
enable the new user to select the game items associated with the one or more tiers above the lowest tier level.

19. The system of claim 18, wherein the inverted progression computing platform is further configured to:
provide, to the user, a basic game item of the hierarchy of game items, wherein the basic game item is associated with a first game reward multiplier;
provide, to the user, an advanced game item of the hierarchy of game items, wherein the advanced game item is worse than the basic game item, wherein the advanced game item corresponds to a first tier that is lower than a second tier of the basic game item, and wherein the advanced game item is associated with a second game reward multiplier that is greater than the first game reward multiplier; and
provide gameplay to the user via the interactive application, wherein providing gameplay to the user comprises allowing the user to use either the basic game item or the advanced game item.

20. The system of claim 18, wherein the inverted progression computing platform is further configured to:
receive gameplay data corresponding to the hierarchy of tiers; and
modify, based on the gameplay data, the hierarchy of tiers, wherein modifying the hierarchy of tiers comprises associating a first game item with a first tier, wherein the first game item was previously associated with a second tier different than the first tier.
